(19) United States
(12) Patent Application Publication
(10) Pub. No.: US 2026/0143531 A1
(43) Pub. Date: May 21, 2026

(54) PHYSICAL RANDOM ACCESS CHANNEL REPETITION FALLBACK FOR A SUB-BAND FULL DUPLEX-AWARE USER EQUIPMENT (UE)

(71) Applicant: QUALCOMM Incorporated, San Diego, CA (US)

(72) Inventors: Ahmed Attia ABOTABL, San Diego, CA (US); Muhammad Sayed Khairy ABDELGHAFFAR, San Jose, CA (US)

(21) Appl. No.: 18/954,301

(22) Filed: Nov. 20, 2024

(51) Int. Cl. H04W 74/0833; H04L 5/14

(52) U.S. Cl. CPC H04W 74/0833; H04L 5/14

(57) ABSTRACT

Methods, systems, and devices for wireless communications are described. In some examples, a user equipment (UE) may transmit a first physical random access channel (PRACH) transmission that include multiple repetitions of a PRACH preamble. In some cases, the UE may support sub-band full duplex (SBFD) operations and may transmit the repetitions via one or more HD slots, one or more SBFD slots, or both. If a random access procedure associated with the PRACH transmission fails, the UE may implement fallback procedures when transmitting a second PRACH transmission. For example, the UE may adjust the quantity of repetitions in the second PRACH transmission to increase a likelihood of successful reception by the network entity. The UE may adjust the quantity of repetitions in the second PRACH transmission in accordance with the HD slots, the SBFD slots, or both.

### FIELD OF TECHNOLOGY

The following relates to wireless communications, including physical random access channel repetition fallback for a sub-band full duplex-aware user equipment (UE).

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving configuration information indicating a first quantity of half-duplex (HD) random access occasions (ROs) and a first quantity of sub-band full duplex (SBFD) ROs for a random access channel (RACH) procedure, transmitting, via the first quantity of HD ROs and the first quantity of SBFD ROs, a first set of repetitions of a physical random access channel (PRACH) message of the RACH procedure in accordance with the configuration information, and transmitting a second set of repetitions of the PRACH message via a second quantity of HD ROs, a second quantity of SBFD ROs, or both, based on a failure of the RACH procedure associated with transmission of the first set of repetitions of the PRACH message, where the second quantity of HD ROs is different from the first quantity of HD ROs, the second quantity of SBFD-duplex ROs is different from the first quantity of SBFD ROs, or both.

A UE for wireless communications is described. The UE may include one or more memories storing processor executable code, and one or more processors coupled with the one or more memories. The one or more processors may individually or collectively be operable to execute the code to cause the UE to receive configuration information indicating a first quantity of HD ROs and a first quantity of SBFD ROs for a RACH procedure, transmit, via the first quantity of HD ROs and the first quantity of SBFD ROs, a first set of repetitions of a PRACH message of the RACH procedure in accordance with the configuration information, and transmit a second set of repetitions of the PRACH message via a second quantity of HD ROs, a second quantity of SBFD ROs, or both, based on a failure of the RACH procedure associated with transmission of the first set of repetitions of the PRACH message, where the second quantity of HD ROs is different from the first quantity of HD ROs, the second quantity of SBFD-duplex ROs is different from the first quantity of SBFD ROs, or both.

Another UE for wireless communications is described. The UE may include means for receiving configuration information indicating a first quantity of HD ROs and a first quantity of SBFD ROs for a RACH procedure, means for transmitting, via the first quantity of HD ROs and the first quantity of SBFD ROs, a first set of repetitions of a PRACH message of the RACH procedure in accordance with the configuration information, and means for transmitting a second set of repetitions of the PRACH message via a second quantity of HD ROs, a second quantity of SBFD ROs, or both, based on a failure of the RACH procedure associated with transmission of the first set of repetitions of the PRACH message, where the second quantity of HD ROs is different from the first quantity of HD ROs, the second quantity of SBFD-duplex ROs is different from the first quantity of SBFD ROs, or both.

A non-transitory computer-readable medium storing code for wireless communications is described. The code may include instructions executable by one or more processors to receive configuration information indicating a first quantity of HD ROs and a first quantity of SBFD ROs for a RACH procedure, transmit, via the first quantity of HD ROs and the first quantity of SBFD ROs, a first set of repetitions of a PRACH message of the RACH procedure in accordance with the configuration information, and transmit a second set of repetitions of the PRACH message via a second quantity of HD ROs, a second quantity of SBFD ROs, or both, based on a failure of the RACH procedure associated with transmission of the first set of repetitions of the PRACH message, where the second quantity of HD ROs is different from the first quantity of HD ROs, the second quantity of SBFD-duplex ROs is different from the first quantity of SBFD ROs, or both.

In some examples of the method, user equipment (UEs), and non-transitory computer-readable medium described herein, a quantity of repetitions of the second set of repetitions may be greater than a quantity of repetitions of the first set of repetitions.

In some examples of the method, UEs, and non-transitory computer-readable medium described herein, the second quantity of HD ROs may be greater than the first quantity of HD ROs.

In some examples of the method, UEs, and non-transitory computer-readable medium described herein, the second quantity of SBFD ROs may be zero and the second quantity of HD ROs may be equal to a sum of the first quantity of HD ROs and the first quantity of SBFD ROs.

In some examples of the method, UEs, and non-transitory computer-readable medium described herein, the first quantity of SBFD ROs may be zero, the second quantity of HD ROs may be greater than the first quantity of HD ROs, and the second quantity of SBFD ROs may be determined opportunistically.

In some examples of the method, UEs, and non-transitory computer-readable medium described herein, the first quantity of SBFD ROs may be determined opportunistically and the second quantity of HD ROs may be greater than the first quantity of HD ROs.

In some examples of the method, UEs, and non-transitory computer-readable medium described herein, the first quantity of SBFD ROs may be zero and the second quantity of HD ROs may be greater than the first quantity HD ROs and the first quantity of HD ROs may be zero and the second quantity of SBFD ROs may be greater than the first quantity SBFD ROs.

In some examples of the method, UEs, and non-transitory computer-readable medium described herein, upon the first quantity of HD ROs being zero, the second quantity of HD ROs may be equal to the first quantity of SBFD ROs.

In some examples of the method, UEs, and non-transitory computer-readable medium described herein, upon the first quantity of HD ROs being zero, the second quantity of HD ROs may be greater than the first quantity of SBFD ROs.

In some examples of the method, UEs, and non-transitory computer-readable medium described herein, the configuration information includes an indication of a quantity of repetitions that the UE may be to transmit.

A method for wireless communications by a network entity is described. The method may include outputting configuration information indicating a first quantity of HD ROs and a first quantity of SBFD ROs for a RACH procedure, monitoring for, via the first quantity of HD ROs and the first quantity of SBFD ROs, a first set of repetitions of a PRACH message of the RACH procedure in accordance with the configuration information, and obtaining a second set of repetitions of the PRACH message via a second quantity of HD ROs, a second quantity of SBFD ROs, or both, based on a failure of the RACH procedure associated with the first set of repetitions of the PRACH message, where the second quantity of HD ROs is different from the first quantity of HD ROs, the second quantity of SBFD-duplex ROs is different from the first quantity of SBFD ROs, or both.

A network entity for wireless communications is described. The network entity may include one or more memories storing processor executable code, and one or more processors coupled with the one or more memories. The one or more processors may individually or collectively be operable to execute the code to cause the network entity to output configuration information indicating a first quantity of HD ROs and a first quantity of SBFD ROs for a RACH procedure, monitor for, via the first quantity of HD ROs and the first quantity of SBFD ROs, a first set of repetitions of a PRACH message of the RACH procedure in accordance with the configuration information, and obtain a second set of repetitions of the PRACH message via a second quantity of HD ROs, a second quantity of SBFD ROs, or both, based on a failure of the RACH procedure associated with the first set of repetitions of the PRACH message, where the second quantity of HD ROs is different from the first quantity of HD ROs, the second quantity of SBFD-duplex ROs is different from the first quantity of SBFD ROs, or both.

Another network entity for wireless communications is described. The network entity may include means for outputting configuration information indicating a first quantity of HD ROs and a first quantity of SBFD ROs for a RACH procedure, means for monitoring for, via the first quantity of HD ROs and the first quantity of SBFD ROs, a first set of repetitions of a PRACH message of the RACH procedure in accordance with the configuration information, and means for obtaining a second set of repetitions of the PRACH message via a second quantity of HD ROs, a second quantity of SBFD ROs, or both, based on a failure of the RACH procedure associated with the first set of repetitions of the PRACH message, where the second quantity of HD ROs is different from the first quantity of HD ROs, the second quantity of SBFD-duplex ROs is different from the first quantity of SBFD ROs, or both.

A non-transitory computer-readable medium storing code for wireless communications is described. The code may include instructions executable by one or more processors to output configuration information indicating a first quantity of HD ROs and a first quantity of SBFD ROs for a RACH procedure, monitor for, via the first quantity of HD ROs and the first quantity of SBFD ROs, a first set of repetitions of a PRACH message of the RACH procedure in accordance with the configuration information, and obtain a second set of repetitions of the PRACH message via a second quantity of HD ROs, a second quantity of SBFD ROs, or both, based on a failure of the RACH procedure associated with the first set of repetitions of the PRACH message, where the second quantity of HD ROs is different from the first quantity of HD ROs, the second quantity of SBFD-duplex ROs is different from the first quantity of SBFD ROs, or both.

In some examples of the method, network entities, and non-transitory computer-readable medium described herein, a quantity of repetitions of the second set of repetitions may be greater than a quantity of repetitions of the first set of repetitions.

In some examples of the method, network entities, and non-transitory computer-readable medium described herein, the second quantity of HD ROs may be greater than the first quantity of HD ROs.

In some examples of the method, network entities, and non-transitory computer-readable medium described herein, the second quantity of SBFD ROs may be zero and the second quantity of HD ROs may be equal to a sum of the first quantity of HD ROs and the first quantity of SBFD ROs.

In some examples of the method, network entities, and non-transitory computer-readable medium described herein, the first quantity of SBFD ROs may be zero, the second quantity of HD ROs may be greater than the first quantity of HD ROs, and the second quantity of SBFD ROs may be determined opportunistically.

In some examples of the method, network entities, and non-transitory computer-readable medium described herein, the first quantity of SBFD ROs may be determined opportunistically and the second quantity of HD ROs may be greater than the first quantity of HD ROs.

In some examples of the method, network entities, and non-transitory computer-readable medium described herein, the first quantity of SBFD ROs may be zero and the second quantity of HD ROs may be greater than the first quantity HD ROs and the first quantity of HD ROs may be zero and the second quantity of SBFD ROs may be greater than the first quantity SBFD ROs.

In some examples of the method, network entities, and non-transitory computer-readable medium described herein, upon the first quantity of HD ROs being zero, the second quantity of HD ROs may be equal to the first quantity of SBFD ROs.

In some examples of the method, network entities, and non-transitory computer-readable medium described herein, upon the first quantity of HD ROs being zero, the second quantity of HD ROs may be greater than the first quantity of SBFD ROs.

In some examples of the method, network entities, and non-transitory computer-readable medium described herein, the configuration information includes an indication of a quantity of repetitions that a UE may transmit.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports physical random access channel repetition fallback for a sub-band full duplex-aware user equipment (UE) in accordance with one or more aspects of the present disclosure.

FIG. 2 shows an example of a wireless communications system that supports PRACH repetition fallback for an SBFD-aware UE in accordance with one or more aspects of the present disclosure.

FIG. 3 shows an example of a signaling diagram that supports PRACH repetition fallback for an SBFD-aware UE in accordance with one or more aspects of the present disclosure.

FIG. 4 shows an example of a signaling diagram that supports PRACH repetition fallback for an SBFD-aware UE in accordance with one or more aspects of the present disclosure.

FIG. 5 shows an example of a process flow that supports PRACH repetition fallback for an SBFD-aware UE in accordance with one or more aspects of the present disclosure.

FIGS. 6 and 7 show block diagrams of devices that support PRACH repetition fallback for an SBFD-aware UE in accordance with one or more aspects of the present disclosure.

FIG. 8 shows a block diagram of a communications manager that supports PRACH repetition fallback for an SBFD-aware UE in accordance with one or more aspects of the present disclosure.

FIG. 9 shows a diagram of a system including a device that supports PRACH repetition fallback for an SBFD-aware UE in accordance with one or more aspects of the present disclosure.

FIGS. 10 and 11 show block diagrams of devices that support PRACH repetition fallback for an SBFD-aware UE in accordance with one or more aspects of the present disclosure.

FIG. 12 shows a block diagram of a communications manager that supports PRACH repetition fallback for an SBFD-aware UE in accordance with one or more aspects of the present disclosure.

FIG. 13 shows a diagram of a system including a device that supports PRACH repetition fallback for an SBFD-aware UE in accordance with one or more aspects of the present disclosure.

FIGS. 14 and 15 show flowcharts illustrating methods that support PRACH repetition fallback for an SBFD-aware UE in accordance with one or more aspects of the present disclosure.

### DETAILED DESCRIPTION

Various aspects related generally to wireless communication and more particularly to transmissions including repetitions of a signal or message. Some aspects more specifically relate to fallback procedures for retransmissions including repetitions. In some examples, a user equipment (UE) may transmit a first physical random access channel (PRACH) transmission to a network entity as a part of a first random access procedure. The PRACH transmission may include multiple instances (e.g., repetitions) of a PRACH preamble. If the first random access procedure fails, the UE may transmit a second PRACH transmission to the network entity as a part of a second random access procedure. The UE may implement fallback procedures when transmitting the second PRACH transmission to improve coverage over uplink. Such fallback procedures may include adjusting a quantity of repetitions in the second PRACH transmission to increase a likelihood of successful reception by the network entity. In some cases, the UE may support half-duplex (HD) and full-duplex (FD) operations, such as sub-band full duplex (SBFD). For example, the UE may transmit the PRACH transmissions via one or more HD slots, one or more SBFD slots, or both. When implementing the fallback procedures, the UE may adjust the quantity of repetitions in the second PRACH transmission in accordance with the HD slots, the SBFD slots, or both. For example, the UE may increase the total quantity of repetitions in the second PRACH transmission by increasing the quantity of repetitions transmitted via HD slots, replacing some repetitions transmitted via SBFD slots with HD slots, or increasing the total quantity of repetitions based on the quantity of repetitions transmitted via HD slots, the quantity of repetitions transmitted via SBFD slots, or both.

Particular aspects of the subject matter described in this disclosure can be implemented to realize one or more of the following potential advantages. Fallback procedures that increase repetitions transmitted in subsequent transmissions provide improved communication reliability and coverage. By implementing fallback procedures for PRACH transmissions transmitted via both HD slots and SBFD slots, aspects of the present disclosure may improve the reliability of random access procedures while continuing to leverage SBFD techniques for increasing throughput. More specifically, the combination of transmitting PRACH repetitions via both HD and SBFD slots and implementing fallback procedures for PRACH retransmissions provides the UE with more slots for transmitting additional PRACH repetitions to increase communication reliability.

Aspects of the disclosure are initially described in the context of wireless communications systems. Aspects of the disclosure are additionally illustrated by signaling diagrams and process flows. Aspects of the disclosure are further illustrated by and described with reference to apparatus diagrams, system diagrams, and flowcharts that relate to PRACH repetition fallback for an SBFD-aware UE.

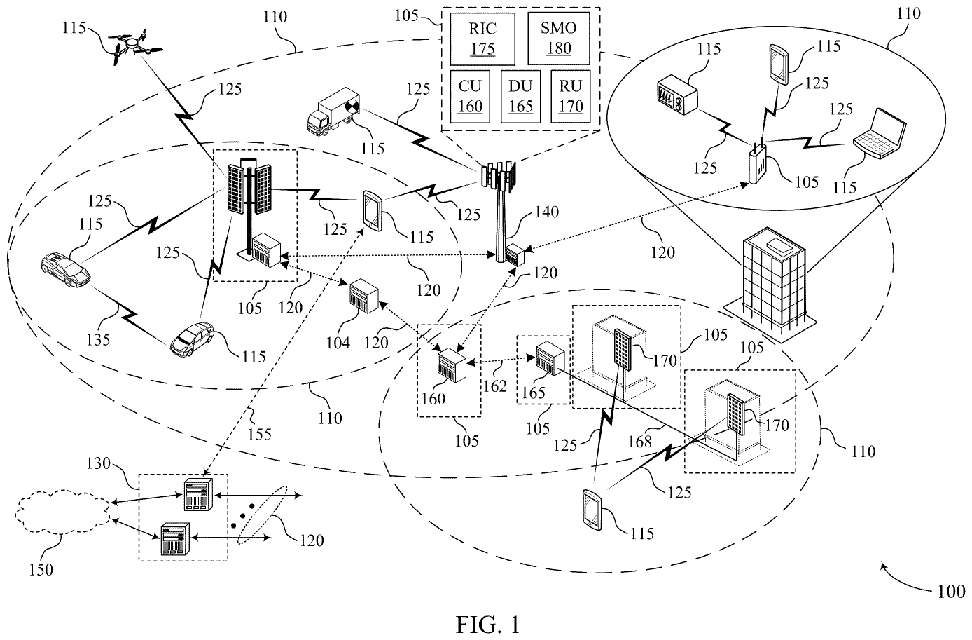

FIG. 1 shows an example of a wireless communications system 100 that supports PRACH repetition fallback for an SBFD-aware UE in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3(L3 ), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1(L1 ) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support PRACH repetition fallback for an SBFD-aware UE as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some examples, a UE 115 may transmit a first PRACH transmission to a network entity 105 as a part of a first random access procedure. The PRACH transmission may include multiple instances (e.g., repetitions) of a PRACH preamble (e.g., a first set of repetitions). If the first random access procedure fails, the UE 115 may transmit a second PRACH transmission to the network entity 105 as a part of a second random access procedure. The UE 115 may implement fallback procedures when transmitting the second PRACH transmission to improve coverage over uplink. Such fallback procedures may include adjusting a quantity of repetitions in the second PRACH transmission to increase a likelihood of successful reception by the network entity 105. In some cases, the UE 115 may support HD and SBFD operations. For example, the UE 115 may transmit the PRACH transmissions via one or more HD slots, one or more SBFD slots, or both. When implementing the fallback procedures, the UE 115 may adjust the quantity of repetitions in the second PRACH transmission (e.g., a second set of repetitions) in accordance with the HD slots, the SBFD slots, or both.

In some examples where the UE 115 is configured to transmit a first quantity of repetitions via HD slots and a second quantity of repetitions via SBFD slots for a first PRACH transmission, the UE 115 may adjust the first quantity of repetitions via HD slots and the second quantity of repetitions via SBFD slots for a second PRACH transmission. In some other examples where the UE 115 is configured to transmit a target quantity of repetitions via HD slots and transmit additional repetitions in available SBFD slots for a first PRACH transmission, the UE 115 may adjust a total quantity of repetitions for a second PRACH transmission in accordance with the target quantity of repetitions via HD slots for the first PRACH transmission or in accordance with the total quantity of repetitions (e.g., via both HD slots and SBFD slots) for the first PRACH transmission. Additionally, or alternatively, the UE 115 may be configured to transmit the quantity of repetitions via a first slot type (e.g., HD slots or SBFD slots) for a first PRACH transmission, but not both. In such cases, the UE 115 may increase the total quantity of repetitions for the second PRACH transmission. If a last repetition of the first PRACH transmission is transmitted via an SBFD slot, the UE 115 may transmit the quantity of repetitions for the second PRACH transmission via a same quantity or an increased quantity of HD slots.

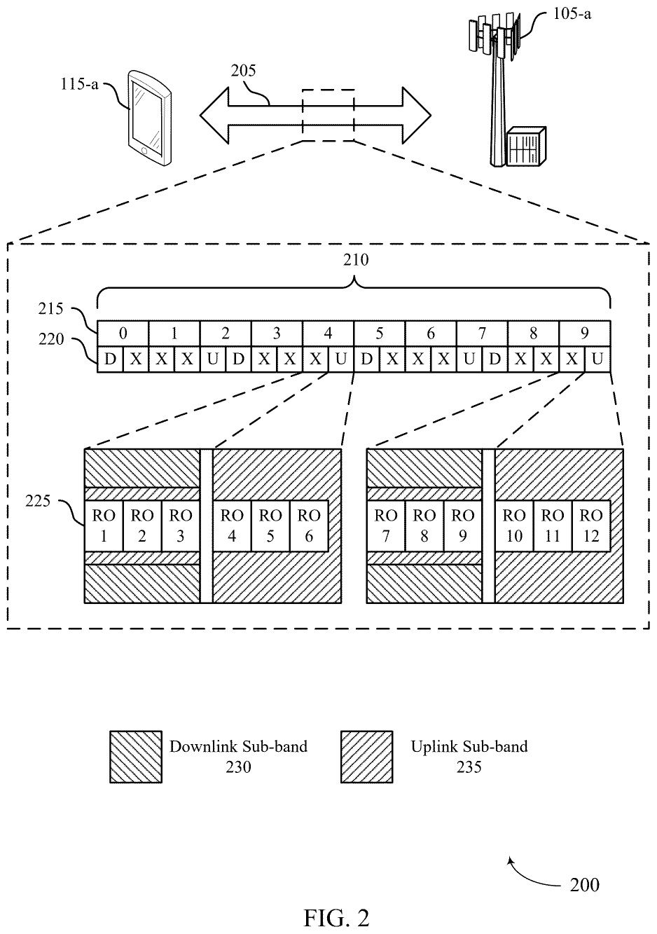

FIG. 2 shows an example of a wireless communications system 200 that supports PRACH repetition fallback for an SBFD-aware UE in accordance with one or more aspects of the present disclosure. The wireless communications system 200 may include a UE 115-a in communications with a network entity 105-a, which may be examples of corresponding devices describes herein, including with reference to FIG. 1. The UE 115-a may communicate with the network entity 105-a via communication link 205, which may be an example of an uplink, downlink, or both. For example, communications between the UE 115-a and the network entity 105-a via the communication link 205 as depicted in the example of FIG. 2 may include uplink communications, downlink communications, or both.

To establish a connection between the UE 115-a and the network entity 105-a, the UE 115-a may initiate a random access procedure (e.g., a physical random access procedure). For example, the UE 115-a may transmit a physical random access channel (PRACH) transmission that includes first message of a RACH procedure (e.g., a RACH Msg1) to initiate random access with the network entity 105-a. The RACH Msg1 may be a physical random access channel (PRACH) preamble. In some examples, the UE 115-a may be configured to transmit the PRACH with repetitions. For example, the UE 115-a may be configured with a quantity of preamble repetitions for the PRACH transmission. The UE 115-a may be configured to transmit the PRACH with repetitions to improve coverage (e.g., over uplink).

In some examples, the UE 115-a may transmit the PRACH repetitions (e.g., the preamble repetitions) within a frame 210. The frame 210 may include multiple subframes 215, and the UE 115-a may be configured to transmit the PRACH repetitions in one or more of the subframes 215. For example, in FIG. 2, the UE 115-a may be configured to transmit PRACH repetitions in a fifth subframe 215 (e.g., subframe 215 with index 4) and in tenth subframe 215 (e.g., subframe 215 with index 9). Each subframe 215 may further include multiple symbols 220 (e.g., slots), and each symbol may include multiple random access occasions (ROs) 225 for transmitting the PRACH repetitions. If the UE 115-a is configured to transmit a quantity of PRACH preamble repetitions, the PRACH repetitions may be transmitted via a group of ROs 225. The group of ROs 225 may include a corresponding set (e.g., quantity) of PRACH occasions that are consecutive in time and that use the same frequency resources.

In some examples, the UE 115-a may support both half duplex (HD) and sub-band full duplex (SBFD) communications. For example, each of the symbols 220 may be configured as an uplink HD symbol U, a downlink HD symbol D, or a SBFD symbol X. In HD communications, the UE 115-a may communicate with the network entity via either uplink or downlink. For example, an HD symbol 220 (e.g., an HD slot) may include a frequency band, which may be an uplink band or a downlink band. In SBFD communications, the UE 115-a may communicate with the network entity 105-a simultaneously via both uplink and downlink. For example, an SBFD symbol 220 (e.g., SBFD slot) may include multiple sub-bands, including a downlink sub-band 230 and an uplink sub-band 235.

In some cases, the UE 115-a may support fallback procedures for transmitting the PRACH transmission. For example, if a RACH procedure associated with a first PRACH transmission (e.g., a first quantity of PRACH repetitions) fails, the UE 115-a may transmit a second PRACH transmission that falls back to a second quantity of PRACH repetitions that is greater than the first quantity of PRACH repetitions. In some cases, the UE may select the second quantity of PRACH repetitions (e.g., the higher quantity of PRACH repetitions) after the first quantity of PRACH repetitions reaches a configured threshold value. For example, the UE 115-a may initially be configured to transmit two PRACH repetitions within a selected set of RACH resources. If the UE 115-a transmits the two PRACH repetitions without successfully completing the random access procedure (e.g., the UE 115-a does not receive a response to the RACH Msg1), the UE 115-a may increase the quantity of PRACH repetitions to four. If the UE 115-a transmits the four PRACH repetitions without successfully completing the random access procedure (e.g., the UE 115-a does not receive a response to the RACH Msg1), the UE 115-a may increase the quantity of PRACH repetitions to eight.

Various aspects of the present disclosure are related to PRACH repetition fallback for SBFD-aware UEs. In some examples, PRACH repetitions of a PRACH transmission may be restricted to one type of RO 225. For example, PRACH repetitions may be restricted to be transmitted via HD ROs 225 (e.g., ROs 225 included in HD symbols 220) or via SBFD ROs 225 (e.g., ROs 225 included in SBFD symbols 220). In such examples, fallback procedures for subsequent PRACH transmissions (e.g., PRACH retransmissions) may include increasing the quantity of PRACH repetitions included in the PRACH retransmissions. For example, the UE 115-a may transmit a first PRACH transmission including a quantity of PRACH repetitions (e.g., a first set of repetitions) transmitted via a first type of RO 225 (e.g., HD RO 225, SBFD RO 225). In some cases, the UE 115-a may fallback to transmitting a higher quantity of PRACH repetitions (e.g., a second set of repetitions) via the first type (e.g., the same type) of RO 225 for a second PRACH transmission. That is, the type of RO 225 associated with the first PRACH transmission may be the same type of RO 225 associated with the second PRACH transmission. In some other cases, the UE 115-a may fallback to transmitting a higher quantity of PRACH repetitions for a second PRACH transmission (e.g., a second set of repetitions) regardless of the first type of RO 225. That is, the type of RO 225 associated with the first set of repetitions may or might not be the same type of RO 225 associated with the second set of repetitions.

Additionally, or alternatively, in some cases where a last PRACH repetition (e.g., of the first set of repetitions) is transmitted via an SBFD RO 225, the UE 115-a may fallback to transmitting PRACH repetitions for a second set of repetitions via HD ROs 225 or via TDD ROs (not shown). The UE 115-a may fallback to transmitting PRACH repetitions for the second set of repetitions via a same quantity of HD ROs 225 (e.g., TDD ROs) as the quantity of SBFD ROs 225 used to transmit the PRACH repetitions of the first set of repetitions, or may increase the quantity of HD ROs 225(e.g., TDD ROs) for transmitting the PRACH repetitions of the second set of repetitions.

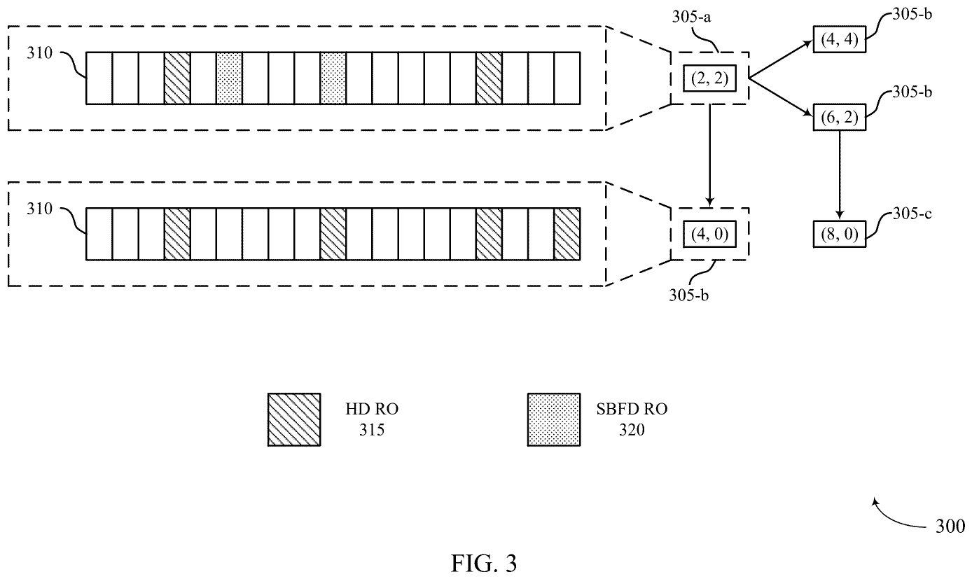

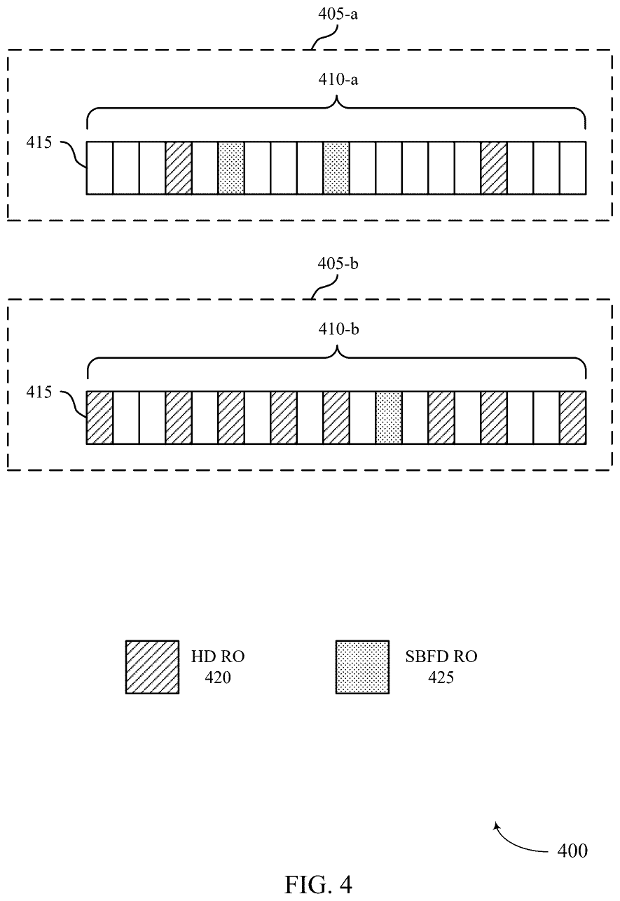

In some other examples, PRACH repetitions may be transmitted across both types of ROs 225. In some cases, a first portion (e.g., first quantity) of the PRACH repetitions may be transmitted via HD ROs 225 and a second portion (e.g., a remaining portion or remaining quantity) of the PRACH repetitions may be transmitted via SBFD ROs 225. Additional details regarding fallback procedures for such examples are described in further detail herein with reference to FIG. 3. In some other cases, PRACH repetitions may be transmitted primarily via HD ROs 225 but may also be transmitted via available SBFD ROs 225 to increase the quantity of ROs 225 that carry PRACH repetitions. For example, the UE 115-a may opportunistically transmit additional (e.g., extra) PRACH repetitions via SBFD symbols 220 that are available within the frame 210. Additional details regarding fallback procedures for such examples are described in further detail herein with reference to FIG. 4.

FIG. 3 shows an example of a signaling diagram 300 that supports PRACH repetition fallback for an SBFD-aware UE in accordance with one or more aspects of the present disclosure. The signaling diagram 300 may illustrate communications between a UE (not shown) and a network entity (not shown), which may be examples of corresponding devices described herein, including with reference to FIGS. 1 and 2. As described herein with reference to FIG. 2, the UE may transmit PRACH transmissions 305 to the network entity. Each PRACH transmission 305 may include multiple ROs 310. For example, each PRACH transmission 305 may include multiple repetitions of a PRACH message, where each repetition is transmitted via one of the multiple ROs 310.

In some examples, a UE 115 may be configured (e.g., by control signaling received from a network entity 105) to transmit a first quantity of repetitions of a PRACH transmission 305 via HD ROs 315, a second quantity of repetitions via SBFD ROs 320, or any combination thereof. For example, in FIG. 3, each PRACH transmission 305 may be defined (e.g., represented) by two values (x, y), where the first value x represents the first quantity of repetitions transmitted via the HD ROs 315 and the second value y represents the second quantity of repetitions transmitted via the SBFD ROs 320. In the example of FIG. 3, the UE may be configured to transmit a first PRACH transmission 305-a (e.g., a first set of repetitions) that includes two repetitions transmitted via HD ROs 315 and two repetitions transmitted via SBFD ROs 320. Accordingly, the first PRACH transmission 305-a may be represented by the expression (2, 2).

If a RACH procedure associated with the first PRACH transmission 305-a fails, the UE may transmit a second PRACH transmission 305-b (e.g., a second set of repetitions) in accordance with one or more fallback procedures. In the example of FIG. 3, because the UE is configured with values for both the first quantity of repetitions transmitted via HD ROs 315 (e.g., 2) and the second quantity of repetitions transmitted via SBFD ROs 320 (e.g., 2), the one or more fallback procedures may include increasing the first quantity of repetitions of the second PRACH transmission 305-b transmitted via HD ROs 315.

In some examples, the UE may increase a total quantity of repetitions included in the second PRACH transmission 305-b (e.g., the second set of repetitions) regardless of the configured values for the first quantity of repetitions transmitted via HD ROs 315 and the second quantity of repetitions transmitted via SBFD ROs 320 for the first PRACH transmission 305-a. For example, the UE may transmit the second PRACH transmission 305-b such that the second PRACH transmission 305-b includes four repetitions transmitted via HD ROs 315 and four repetitions transmitted via SBFD ROs 320. Accordingly, the second PRACH transmission 305-b may be represented by the expression (4, 4).

In some other examples, the UE may increase a total quantity of repetitions included in the second PRACH transmission 305-b by increasing the quantity of repetitions of the second PRACH transmission 305-b transmitted via HD ROs 315. For example, the first PRACH transmission 305-a may include a total of four repetitions, including two repetitions transmitted via HD ROs 315 and two repetitions transmitted via SBFD ROs 320. In such cases, the UE may transmit the second PRACH transmission 305-b such that the second PRACH transmission 305-b includes a total of eight repetitions. Of the eight repetitions in the second PRACH transmission 305-b, the UE may maintain the quantity of repetitions transmitted via SBFD ROs 320 (e.g., 2), such that six repetitions are transmitted via HD ROs 315. Accordingly, the second PRACH transmission 305-b may be represented by the expression (6, 2).

Additionally, or alternatively, the UE may maintain the total quantity of repetitions but replace the SBFD ROs 320 with HD ROs 315. For example, the first PRACH transmission 305-a may include a total of four repetitions, including two repetitions transmitted via HD ROs 315 and two repetitions transmitted via SBFD ROs 320. In such cases, the UE may transmit the second PRACH transmission 305-b such that the second PRACH transmission 305-b includes a total of four repetitions. Of the four repetitions in the second PRACH transmission 305-b, the UE may replace the two repetitions transmitted via SBFD ROs 320 with two additional repetitions transmitted via HD ROs 315, such that all four repetitions are transmitted via HD ROs 315. Accordingly, the second PRACH transmission 305-b may be represented by the expression (4, 0).

If a second RACH procedure associated with repetitions of the second PRACH transmission 305-b (e.g., the second set of repetitions) also fails, the UE may transmit a third PRACH transmission 305-c (e.g., a third set of repetitions) in accordance with the one or more fallback procedures. For example, the UE may transmit the second PRACH transmission 305-b including eight repetitions, where six repetitions are transmitted via HD ROs 315 and where two repetitions are transmitted via SBFD ROs 320. In such cases, the UE may maintain the total quantity of repetitions between the second PRACH transmission 305-b and the third PRACH transmission 305-c. Of the eight repetitions in the third PRACH transmission 305-c, the UE may replace the two repetitions transmitted via SBFD ROs 320 with two additional repetitions transmitted via HD ROs 315, such that all eight repetitions are transmitted via HD ROs 315. Accordingly, the third PRACH transmission 305-c may be represented by the expression (8, 0).

FIG. 4 shows an example of a signaling diagram 400 that supports PRACH repetition fallback for an SBFD-aware UE in accordance with one or more aspects of the present disclosure. The signaling diagram 400 may illustrate communications between a UE (not shown) and a network entity (not shown), which may be examples of corresponding devices described herein, including with reference to FIGS. 1 and 2. As described herein with reference to FIG. 2, the UE 115 may transmit PRACH transmissions to the network entity. In some examples, each PRACH transmission may include multiple repetitions of a PRACH message. For example, in FIG. 4, each PRACH transmission may include a first set of PRACH repetitions 405-a and a second set of PRACH repetitions 405-b. In such examples, the UE may fallback from transmitting the first set of PRACH repetitions 405-a to transmitting the second set of PRACH repetitions 405-b (e.g., in response to a failed random access procedure associated with the first set of PRACH repetitions 405-a).

The first set of PRACH repetitions 405-a may span a duration 410-a, and the second set of PRACH repetitions 405-b may span a duration 410-b, both of which may include multiple ROs 415. The UE may transmit the repetitions via the multiple ROs 415. In the example of FIG. 4, the multiple ROs 415 that are used to transmit the repetitions of the first set of PRACH repetitions 405-a may include HD ROs 420, SBFD ROs 425, or both. In the example of FIG. 4, the UE may be configured (e.g., via control signaling received from the network entity) to transmit the first set of PRACH repetitions 405-a via a set of HD ROs 420 during the duration 410-a. The set of HD ROs 420 may correspond to a targeted quantity of repetitions N transmitted via HD ROs 420. If the UE determines that there are one or more SBFD ROs 425 available during the duration 410-a, the UE may also opportunistically transmit one or more additional PRACH repetitions 405-a via the one or more SBFD ROs 425. In this way, the UE may transmit the first set of PRACH repetitions 405-a via both the set of HD ROs 420 and one or more SBFD ROs 425, which may increase a total quantity of repetitions in the first set of PRACH repetitions 405-a and improve uplink coverage.

For example, in FIG. 4, the UE may be configured to transmit a first set of PRACH repetitions 405-a that includes two repetitions transmitted via the set of HD ROs 420. The first set of PRACH repetitions 405-a may also include two repetitions opportunistically transmitted via SBFD ROs 425 that were available during the duration 410-a (e.g., not scheduled for uplink or downlink communications). If a RACH procedure associated with the first set of PRACH repetitions 405-a fails, the UE may transmit the second set of PRACH repetitions 405-b in accordance with one or more fallback procedures. In the example of FIG. 4, because the UE is configured for opportunistic repetition, the one or more fallback procedures may include increasing the quantity of HD ROs 420 for transmitting the second set of PRACH repetitions 405-b.

In some examples, a baseline value for a total quantity of repetitions to include in the second set of PRACH repetitions 405-b may be equal to the quantity of HD ROs 420 used to transmit the first set of PRACH repetitions 405-a. The baseline value may exclude the quantity of opportunistic SBFD ROs 425 in the first set of PRACH repetitions 405-a. In accordance with one or more fallback procedures, the UE may increase the quantity of HD ROs 420 for transmitting the second set of PRACH repetitions 405-b relative to the baseline value. For example, the first set of PRACH repetitions 405-a may include a total of four repetitions, including two repetitions transmitted via HD ROs 420 and two repetitions transmitted via SBFD ROs 425. In such cases, the baseline value may be equal to two, and the UE may fallback to transmitting the second set of PRACH repetitions 405-b based on the baseline value. For example, the UE may transmit the second set of PRACH repetitions 405-b such that the second set of PRACH repetitions 405-b includes a total of four repetitions transmitted via HD ROs 420. The UE may continue to opportunistically transmit additional repetitions in SBFD ROs 425 that are available during the duration 410-b such that the second set of PRACH repetitions may include more repetitions than the target quantity of repetitions.

In some other examples, a baseline value for the total quantity of repetitions to include in the second set of PRACH repetitions 405-b may be equal to a sum of the quantity of HD ROs 420 and the quantity of SBFD ROs 425 used to transmit the first set of PRACH repetitions 405-a. In accordance with one or more fallback procedures, the UE may increase the quantity of HD ROs 420 for transmitting the second set of PRACH repetitions 405-b. For example, as illustrated in FIG. 4, the first set of PRACH repetitions 405-a may include a total of four repetitions, including two repetitions transmitted via HD ROs 420 and two repetitions transmitted via SBFD ROs 425. In such cases, the baseline value may be equal to four, and the UE may fallback to transmitting the second set of PRACH repetitions 405-b based on the baseline value. For example, the UE may transmit the second set of PRACH repetitions 405-b such that the second set of PRACH repetitions 405-b includes a total of eight repetitions transmitted via HD ROs 420. The UE may continue to transmit additional repetitions in SBFD ROs 425 that are available during the duration 410-b such that the second set of PRACH repetitions 405-b may include more repetitions than the target quantity of repetitions.

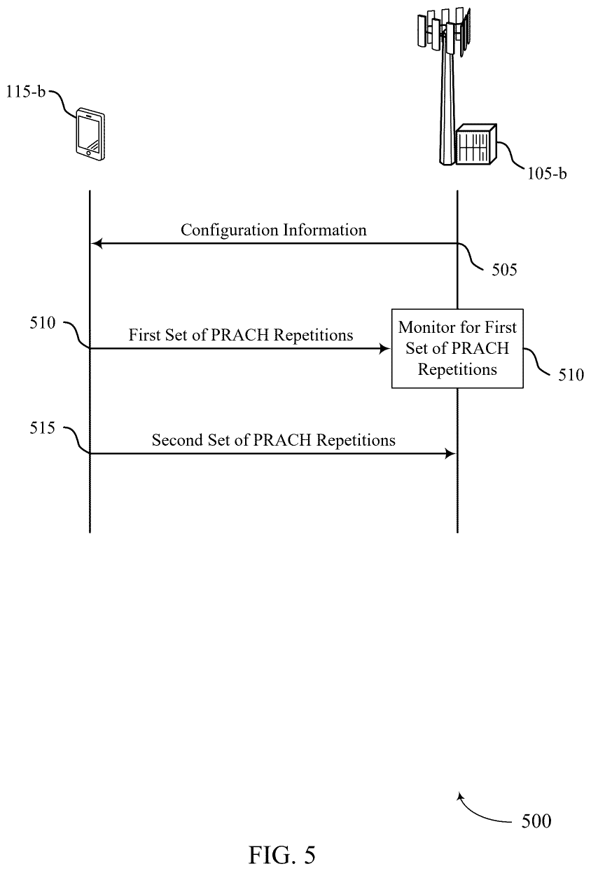

FIG. 5 shows an example of a process flow 500 that supports PRACH repetition fallback for an SBFD-aware UE in accordance with one or more aspects of the present disclosure. The process flow 500 may implement or be implemented by aspects of the wireless communications system 100, the wireless communications system 200, the signaling diagram 300, and the signaling diagram 400 as described herein with reference to FIGS. 1, 2, 3, and 4. For example, the process flow 500 may illustrate actions performed by a UE 115-b and a network entity 105-b. In the following description of the process flow 500, the operations between the UE 115-b and the network entity 105-b may be performed in a different order than the example shown, or the operations between the UE 115-b and the network entity 105-b may be performed in different orders at different times. Some operations may also be omitted from the process flow 500, and other operations may be added to the process flow 500.

At 505, the UE 115-b may receive configuration information indicating a first quantity of HD ROs and a first quantity of SBFD ROs for a RACH procedure. In some examples, the configuration information may include an indication of a quantity of repetitions (e.g., of a PRACH message) that the UE is to transmit (e.g., via the first quantity of HD ROs, the first quantity of SBFD ROs, or both).

At 510, the UE 115-b may transmit, via the first quantity of HD ROs and the first quantity of SBFD ROs, a first set of repetitions of the PRACH message of the RACH procedure in accordance with the configuration information. The network entity 105-b may monitor for, via the first quantity of HD ROs and the first quantity of SBFD ROs, the first set of repetitions of the PRACH message of the RACH procedure in accordance with the configuration information.

At 515, the UE 115-b may transmit a second set of repetitions of the PRACH message via a second quantity of HD ROs, a second quantity of SBFD ROs, or both, based on a failure of the RACH procedure associated with transmission of the first set of repetitions of the PRACH message. The second quantity of HD ROs may be different from the first quantity of HD ROs, the second quantity of SBFD ROs may be different from the first quantity of SBFD ROs, or both. The network entity 105-b may obtain (e.g., receive) the second set of repetitions of the PRACH message via the second quantity of HD ROs, the second quantity of SBFD ROs, or both, based on a failure of the RACH procedure associated with the first set of repetitions of the PRACH message.

In some examples, a quantity of repetitions of the second set of repetitions may be greater than a quantity of repetitions of the first set of repetitions. For example, in some cases the second quantity of HD ROs may be greater than the first quantity of HD ROs. In some other cases, the second quantity of SBFD ROs may be zero, and the second quantity of HD ROs may be equal to a sum of the first quantity of HD ROs and the first quantity of SBFD ROs.

In some other examples, the first quantity of SBFD ROs may be zero, the second quantity of HD ROs may be greater than the first quantity of HD ROs, and the second quantity of SBFD ROs may be determined opportunistically. For example, the second quantity of SBFD ROs may be determined based on the second quantity of HD ROs. Additionally, or alternatively, the first quantity of SBFD ROs may be determined opportunistically, and the second quantity of HD ROs may be greater than the first quantity of HD ROs.

Alternatively, in some cases where the UE 115-b is configured to transmit the first set of repetitions via the first quantity of HD ROs, the first quantity of SBFD ROs may be zero. In such cases where the first quantity of SBFD ROs is zero, the second quantity of HD ROs may be greater than the first quantity of HD ROs. In some other cases where the UE 115-b is configured to transmit the first set of repetitions via the first quantity of SBFD ROs, the first quantity of HD ROs may be zero. In such cases where the first quantity of HD ROs is zero, the second quantity of SBFD ROs may be greater than the first quantity SBFD ROs. In some cases, upon the first quantity of HD ROs being zero, the second quantity of HD ROs may be equal to the first quantity of SBFD ROs or may be greater than the first quantity of SBFD ROs.

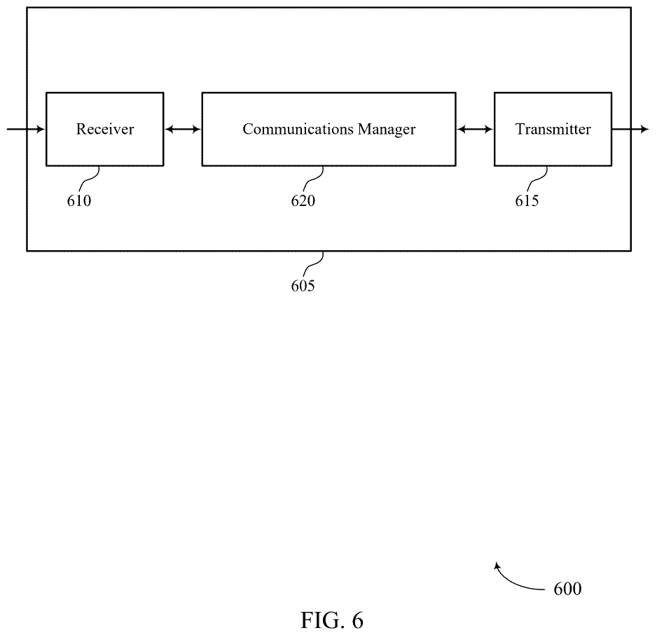

FIG. 6 shows a block diagram 600 of a device 605 that supports PRACH repetition fallback for an SBFD-aware UE in accordance with one or more aspects of the present disclosure. The device 605 may be an example of aspects of a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to PRACH repetition fallback for an SBFD-aware UE). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to PRACH repetition fallback for an SBFD-aware UE). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations or components thereof may be examples of means for performing various aspects of PRACH repetition fallback for an SBFD-aware UE as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor (e.g., referred to as a processor-executable code). If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. For example, the communications manager 620 is capable of, configured to, or operable to support a means for receiving configuration information indicating a first quantity of HD ROs and a first quantity of SBFD ROs for a RACH procedure. The communications manager 620 is capable of, configured to, or operable to support a means for transmitting, via the first quantity of HD ROs and the first quantity of SBFD ROs, a first set of repetitions of a PRACH message of the RACH procedure in accordance with the configuration information. The communications manager 620 is capable of, configured to, or operable to support a means for transmitting a second set of repetitions of the PRACH message via a second quantity of HD ROs, a second quantity of SBFD ROs, or both, based on a failure of the RACH procedure associated with transmission of the first set of repetitions of the PRACH message, where the second quantity of HD ROs is different from the first quantity of HD ROs, the second quantity of SBFD-duplex ROs is different from the first quantity of SBFD ROs, or both.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for more efficient utilization of communication resources.

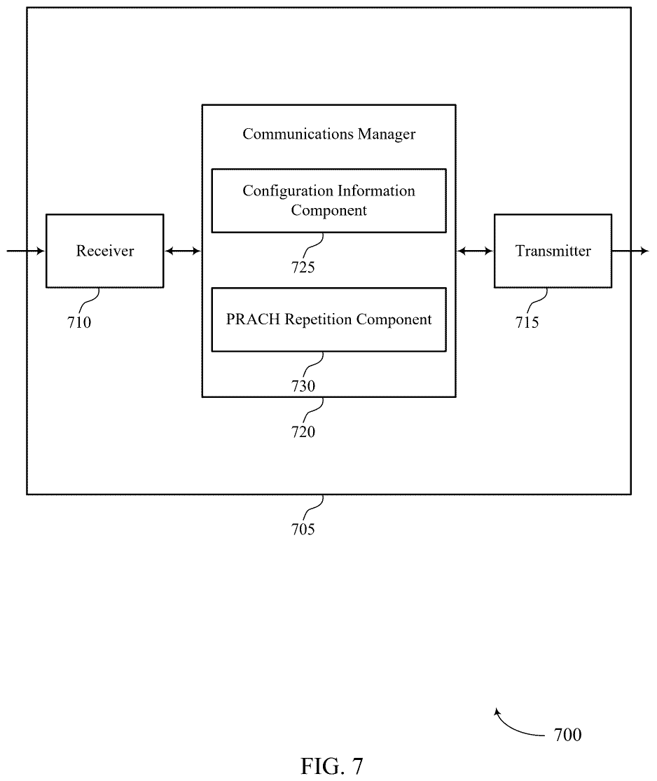

FIG. 7 shows a block diagram 700 of a device 705 that supports PRACH repetition fallback for an SBFD-aware UE in accordance with one or more aspects of the present disclosure. The device 705 may be an example of aspects of a device 605 or a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to PRACH repetition fallback for an SBFD-aware UE). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to PRACH repetition fallback for an SBFD-aware UE). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of PRACH repetition fallback for an SBFD-aware UE as described herein. For example, the communications manager 720 may include a configuration information component 725 a PRACH repetition component 730, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. The configuration information component 725 is capable of, configured to, or operable to support a means for receiving configuration information indicating a first quantity of HD ROs and a first quantity of SBFD ROs for a RACH procedure. The PRACH repetition component 730 is capable of, configured to, or operable to support a means for transmitting, via the first quantity of HD ROs and the first quantity of SBFD ROs, a first set of repetitions of a PRACH message of the RACH procedure in accordance with the configuration information. The PRACH repetition component 730 is capable of, configured to, or operable to support a means for transmitting a second set of repetitions of the PRACH message via a second quantity of HD ROs, a second quantity of SBFD ROs, or both, based on a failure of the RACH procedure associated with transmission of the first set of repetitions of the PRACH message, where the second quantity of HD ROs is different from the first quantity of HD ROs, the second quantity of SBFD-duplex ROs is different from the first quantity of SBFD ROs, or both.

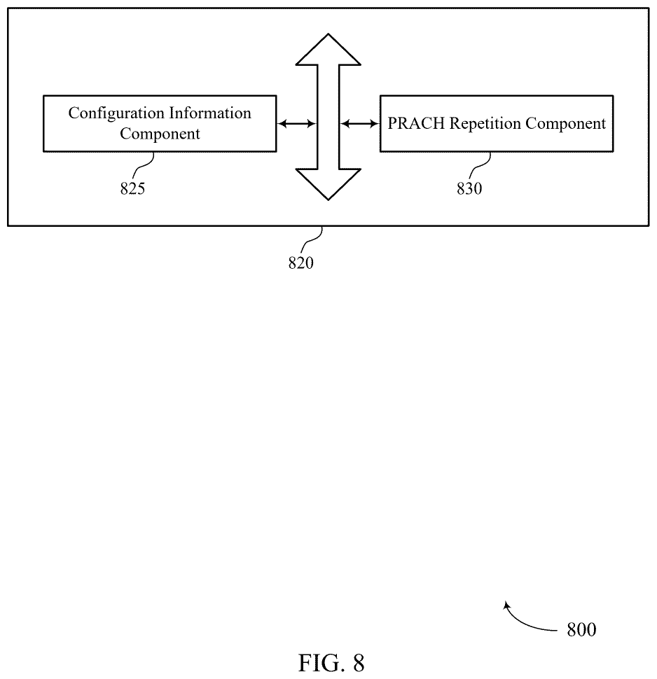

FIG. 8 shows a block diagram 800 of a communications manager 820 that supports PRACH repetition fallback for an SBFD-aware UE in accordance with one or more aspects of the present disclosure. The communications manager 820 may be an example of aspects of a communications manager 620, a communications manager 720, or both, as described herein. The communications manager 820, or various components thereof, may be an example of means for performing various aspects of PRACH repetition fallback for an SBFD-aware UE as described herein. For example, the communications manager 820 may include a configuration information component 825 a PRACH repetition component 830, or any combination thereof. Each of these components, or components or subcomponents thereof (e.g., one or more processors, one or more memories), may communicate, directly or indirectly, with one another (e.g., via one or more buses).

The communications manager 820 may support wireless communications in accordance with examples as disclosed herein. The configuration information component 825 is capable of, configured to, or operable to support a means for receiving configuration information indicating a first quantity of HD ROs and a first quantity of SBFD ROs for a RACH procedure. The PRACH repetition component 830 is capable of, configured to, or operable to support a means for transmitting, via the first quantity of HD ROs and the first quantity of SBFD ROs, a first set of repetitions of a PRACH message of the RACH procedure in accordance with the configuration information. In some examples, the PRACH repetition component 830 is capable of, configured to, or operable to support a means for transmitting a second set of repetitions of the PRACH message via a second quantity of HD ROs, a second quantity of SBFD ROs, or both, based on a failure of the RACH procedure associated with transmission of the first set of repetitions of the PRACH message, where the second quantity of HD ROs is different from the first quantity of HD ROs, the second quantity of SBFD-duplex ROs is different from the first quantity of SBFD ROs, or both.

In some examples, a quantity of repetitions of the second set of repetitions is greater than a quantity of repetitions of the first set of repetitions.

In some examples, the second quantity of HD ROs is greater than the first quantity of HD ROs.

In some examples, the second quantity of SBFD ROs is zero and the second quantity of HD ROs is equal to a sum of the first quantity of HD ROs and the first quantity of SBFD ROs.

In some examples, the first quantity of SBFD ROs is zero, the second quantity of HD ROs is greater than the first quantity of HD ROs, and the second quantity of SBFD ROs are determined opportunistically.

In some examples, the first quantity of SBFD ROs are determined opportunistically and the second quantity of HD ROs is greater than the first quantity of HD ROs.

In some examples, the first quantity of SBFD ROs is zero and the second quantity of HD ROs is greater than the first quantity HD ROs. In some examples, the first quantity of HD ROs is zero and the second quantity of SBFD ROs is greater than the first quantity SBFD ROs.

In some examples, upon the first quantity of HD ROs being zero, the second quantity of HD ROs is equal to the first quantity of SBFD ROs.

In some examples, upon the first quantity of HD ROs being zero, the second quantity of HD ROs is greater than the first quantity of SBFD ROs.

In some examples, the configuration information includes an indication of a quantity of repetitions that the UE is to transmit.

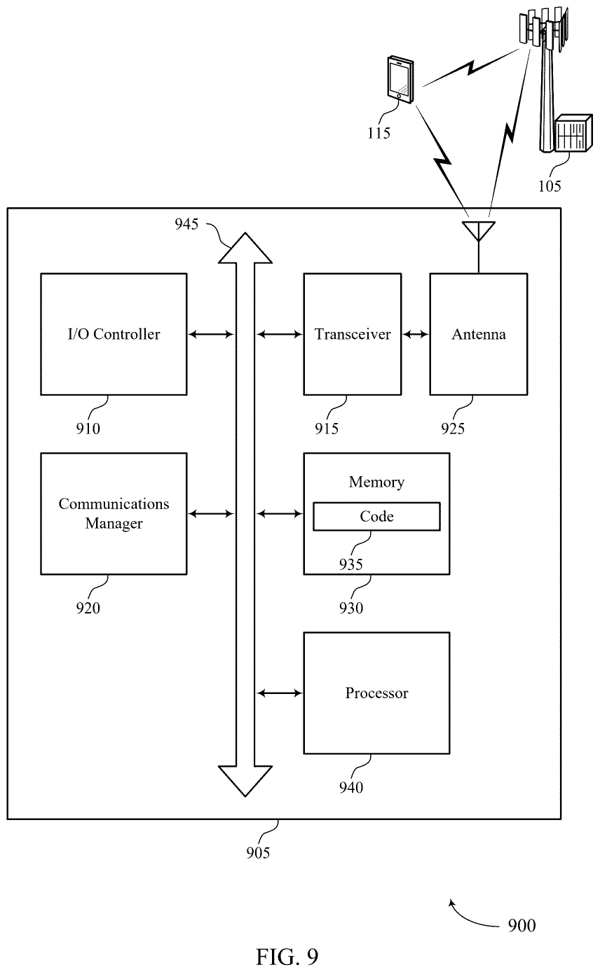

FIG. 9 shows a diagram of a system 900 including a device 905 that supports PRACH repetition fallback for an SBFD-aware UE in accordance with one or more aspects of the present disclosure. The device 905 may be an example of or include components of a device 605, a device 705, or a UE 115 as described herein. The device 905 may communicate (e.g., wirelessly) with one or more other devices (e.g., network entities 105, UEs 115, or a combination thereof). The device 905 may include components for bi-directional voice and data communications including components for transmitting and receiving communications, such as a communications manager 920, an input/output (I/O) controller, such as an I/O controller 910, a transceiver 915, one or more antennas 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna. However, in some other cases, the device 905 may have more than one antenna, which may be capable of concurrently transmitting or receiving multiple wireless transmissions. The transceiver 915 may communicate bi-directionally via the one or more antennas 925 using wired or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable, or processor-executable code, such as the code 935. The code 935 may include instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may include, among other things, a basic I/O system (BIOS) which may control basic hardware or software operation such as the interaction with peripheral components or devices.

The at least one processor 940 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting PRACH repetition fallback for an SBFD-aware UE). For example, the device 905 or a component of the device 905 may include at least one processor 940 and at least one memory 930 coupled with or to the at least one processor 940, the at least one processor 940 and the at least one memory 930 configured to perform various functions described herein.

In some examples, the at least one processor 940 may include multiple processors and the at least one memory 930 may include multiple memories. One or more of the multiple processors may be coupled with one or more of the multiple memories, which may, individually or collectively, be configured to perform various functions described herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. For example, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code 935 (e.g., processor-executable code) stored in the at least one memory 930 or otherwise, to perform one or more of the functions described herein.

The communications manager 920 may support wireless communications in accordance with examples as disclosed herein. For example, the communications manager 920 is capable of, configured to, or operable to support a means for receiving configuration information indicating a first quantity of HD ROs and a first quantity of SBFD ROs for a RACH procedure. The communications manager 920 is capable of, configured to, or operable to support a means for transmitting, via the first quantity of HD ROs and the first quantity of SBFD ROs, a first set of repetitions of a PRACH message of the RACH procedure in accordance with the configuration information. The communications manager 920 is capable of, configured to, or operable to support a means for transmitting a second set of repetitions of the PRACH message via a second quantity of HD ROs, a second quantity of SBFD ROs, or both, based on a failure of the RACH procedure associated with transmission of the first set of repetitions of the PRACH message, where the second quantity of HD ROs is different from the first quantity of HD ROs, the second quantity of SBFD-duplex ROs is different from the first quantity of SBFD ROs, or both.

By including or configuring the communications manager 920 in accordance with examples as described herein, the device 905 may support techniques for improved communication reliability, reduced latency and improved user experience related to more efficient utilization of communication resources and improved coordination between devices.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of PRACH repetition fallback for an SBFD-aware UE as described herein, or the at least one processor 940 and the at least one memory 930 may be otherwise configured to, individually or collectively, perform or support such operations.

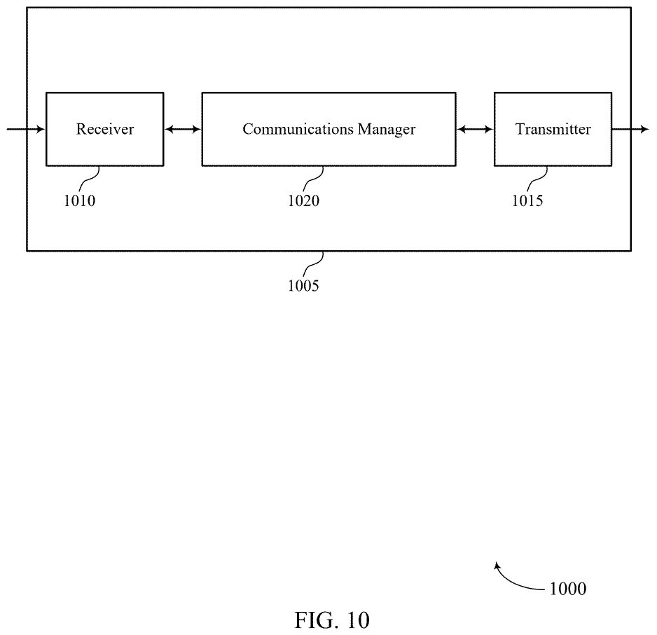

FIG. 10 shows a block diagram 1000 of a device 1005 that supports PRACH repetition fallback for an SBFD-aware UE in accordance with one or more aspects of the present disclosure. The device 1005 may be an example of aspects of a network entity 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to, individually or collectively, support or enable the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations or components thereof may be examples of means for performing various aspects of PRACH repetition fallback for an SBFD-aware UE as described herein. For example, the communications manager 1020, the receiver 1010, the transmitter 1015, or various combinations or components thereof may be capable of performing one or more of the functions described herein.

In some examples, the communications manager 1020, the receiver 1010, the transmitter 1015, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1020, the receiver 1010, the transmitter 1015, or various combinations or components thereof may be implemented in code (e.g., as communications management software or firmware) executed by at least one processor (e.g., referred to as a processor-executable code). If implemented in code executed by at least one processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. For example, the communications manager 1020 is capable of, configured to, or operable to support a means for outputting configuration information indicating a first quantity of HD ROs and a first quantity of SBFD ROs for a RACH procedure. The communications manager 1020 is capable of, configured to, or operable to support a means for monitoring for, via the first quantity of HD ROs and the first quantity of SBFD ROs, a first set of repetitions of a PRACH message of the RACH procedure in accordance with the configuration information. The communications manager 1020 is capable of, configured to, or operable to support a means for obtaining a second set of repetitions of the PRACH message via a second quantity of HD ROs, a second quantity of SBFD ROs, or both, based on a failure of the RACH procedure associated with the first set of repetitions of the PRACH message, where the second quantity of HD ROs is different from the first quantity of HD ROs, the second quantity of SBFD-duplex ROs is different from the first quantity of SBFD ROs, or both.

By including or configuring the communications manager 1020 in accordance with examples as described herein, the device 1005 (e.g., at least one processor controlling or otherwise coupled with the receiver 1010, the transmitter 1015, the communications manager 1020, or a combination thereof) may support techniques for more efficient utilization of communication resources.

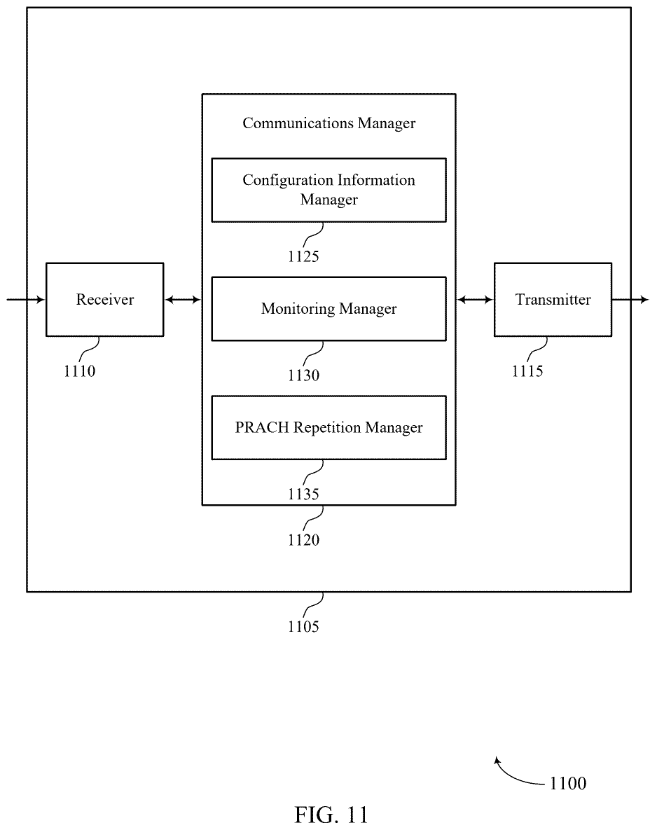

FIG. 11 shows a block diagram 1100 of a device 1105 that supports PRACH repetition fallback for an SBFD-aware UE in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105, or one or more components of the device 1105 (e.g., the receiver 1110, the transmitter 1115, the communications manager 1120), may include at least one processor, which may be coupled with at least one memory, to support the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of PRACH repetition fallback for an SBFD-aware UE as described herein. For example, the communications manager 1120 may include a configuration information manager 1125, a monitoring manager 1130, a PRACH repetition manager 1135, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. The configuration information manager 1125 is capable of, configured to, or operable to support a means for outputting configuration information indicating a first quantity of HD ROs and a first quantity of SBFD ROs for a RACH procedure. The monitoring manager 1130 is capable of, configured to, or operable to support a means for monitoring for, via the first quantity of HD ROs and the first quantity of SBFD ROs, a first set of repetitions of a PRACH message of the RACH procedure in accordance with the configuration information. The PRACH repetition manager 1135 is capable of, configured to, or operable to support a means for obtaining a second set of repetitions of the PRACH message via a second quantity of HD ROs, a second quantity of SBFD ROs, or both, based on a failure of the RACH procedure associated with the first set of repetitions of the PRACH message, where the second quantity of HD ROs is different from the first quantity of HD ROs, the second quantity of SBFD-duplex ROs is different from the first quantity of SBFD ROs, or both.

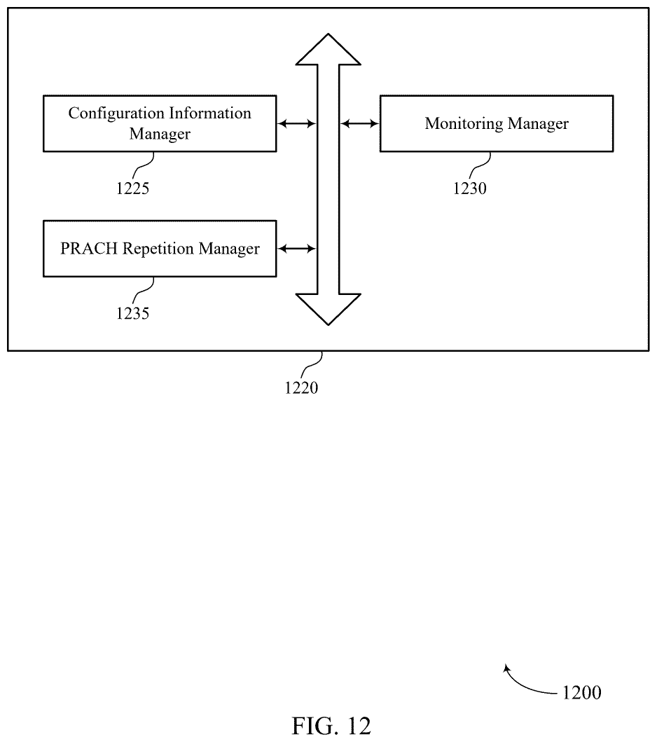

FIG. 12 shows a block diagram 1200 of a communications manager 1220 that supports PRACH repetition fallback for an SBFD-aware UE in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of PRACH repetition fallback for an SBFD-aware UE as described herein. For example, the communications manager 1220 may include a configuration information manager 1225, a monitoring manager 1230, a PRACH repetition manager 1235, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communications in accordance with examples as disclosed herein. The configuration information manager 1225 is capable of, configured to, or operable to support a means for outputting configuration information indicating a first quantity of HD ROs and a first quantity of SBFD ROs for a RACH procedure. The monitoring manager 1230 is capable of, configured to, or operable to support a means for monitoring for, via the first quantity of HD ROs and the first quantity of SBFD ROs, a first set of repetitions of a PRACH message of the RACH procedure in accordance with the configuration information. The PRACH repetition manager 1235 is capable of, configured to, or operable to support a means for obtaining a second set of repetitions of the PRACH message via a second quantity of HD ROs, a second quantity of SBFD ROs, or both, based on a failure of the RACH procedure associated with the first set of repetitions of the PRACH message, where the second quantity of HD ROs is different from the first quantity of HD ROs, the second quantity of SBFD-duplex ROs is different from the first quantity of SBFD ROs, or both.

In some examples, a quantity of repetitions of the second set of repetitions is greater than a quantity of repetitions of the first set of repetitions.

In some examples, the second quantity of HD ROs is greater than the first quantity of HD ROs.

In some examples, the second quantity of SBFD ROs is zero and the second quantity of HD ROs is equal to a sum of the first quantity of HD ROs and the first quantity of SBFD ROs.

In some examples, the first quantity of SBFD ROs is zero, the second quantity of HD ROs is greater than the first quantity of HD ROs, and the second quantity of SBFD ROs are determined opportunistically.

In some examples, the first quantity of SBFD ROs are determined opportunistically and the second quantity of HD ROs is greater than the first quantity of HD ROs.

In some examples, the first quantity of SBFD ROs is zero and the second quantity of HD ROs is greater than the first quantity HD ROs. In some examples, the first quantity of HD ROs is zero and the second quantity of SBFD ROs is greater than the first quantity SBFD ROs.

In some examples, upon the first quantity of HD ROs being zero, the second quantity of HD ROs is equal to the first quantity of SBFD ROs.

In some examples, upon the first quantity of HD ROs being zero, the second quantity of HD ROs is greater than the first quantity of SBFD ROs.

In some examples, the configuration information includes an indication of a quantity of repetitions that a user equipment is to transmit.

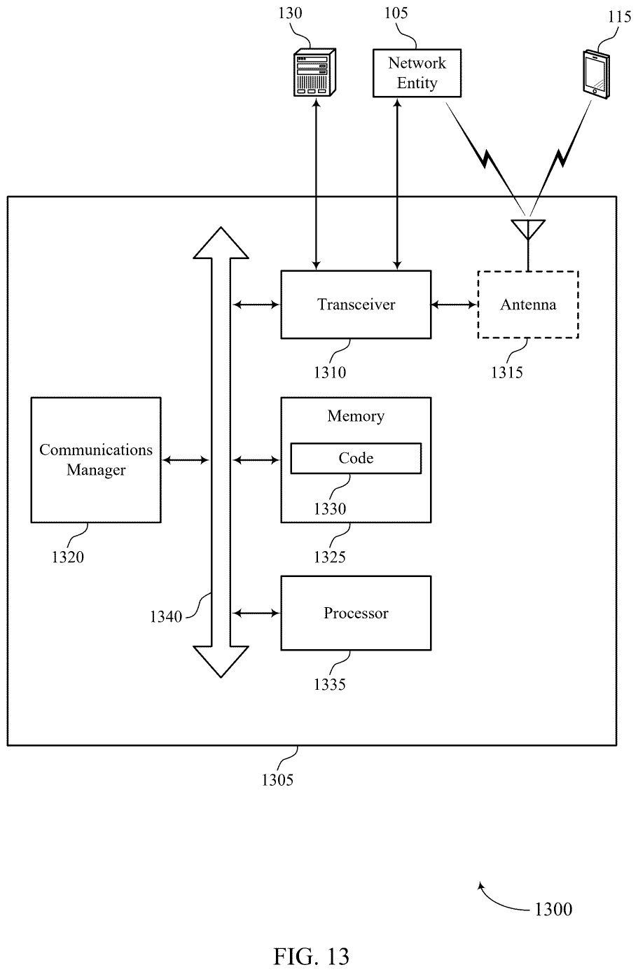

FIG. 13 shows a diagram of a system 1300 including a device 1305 that supports PRACH repetition fallback for an SBFD-aware UE in accordance with one or more aspects of the present disclosure. The device 1305 may be an example of or include components of a device 1005, a device 1105, or a network entity 105 as described herein. The device 1305 may communicate with other network devices or network equipment such as one or more of the network entities 105, UEs 115, or any combination thereof. The communications may include communications over one or more wired interfaces, over one or more wireless interfaces, or any combination thereof. The device 1305 may include components that support outputting and obtaining communications, such as a communications manager 1320, a transceiver 1310, one or more antennas 1315, at least one memory 1325, code 1330, and at least one processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or one or more memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or one or more memory components (e.g., the at least one processor 1335, the at least one memory 1325, or both), may be included in a chip or chip assembly that is installed in the device 1305. In some examples, the transceiver 1310 may be operable to support communications via one or more communications links (e.g., communication link(s) 125, backhaul communication link(s) 120, a midhaul communication link 162, a fronthaul communication link 168).

The at least one memory 1325 may include RAM, ROM, or any combination thereof. The at least one memory 1325 may store computer-readable, computer-executable, or processor-executable code, such as the code 1330. The code 1330 may include instructions that, when executed by one or more of the at least one processor 1335, cause the device 1305 to perform various functions described herein. The code 1330 may be stored in a non-transitory computer-readable medium such as system memory or another type of memory. In some cases, the code 1330 may not be directly executable by a processor of the at least one processor 1335 but may cause a computer (e.g., when compiled and executed) to perform functions described herein. In some cases, the at least one memory 1325 may include, among other things, a BIOS which may control basic hardware or software operation such as the interaction with peripheral components or devices. In some examples, the at least one processor 1335 may include multiple processors and the at least one memory 1325 may include multiple memories. One or more of the multiple processors may be coupled with one or more of the multiple memories which may, individually or collectively, be configured to perform various functions herein (for example, as part of a processing system).

The at least one processor 1335 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1335 may be configured to operate a memory array using a memory controller. In some other cases, a memory controller may be integrated into one or more of the at least one processor 1335. The at least one processor 1335 may be configured to execute computer-readable instructions stored in a memory (e.g., one or more of the at least one memory 1325) to cause the device 1305 to perform various functions (e.g., functions or tasks supporting PRACH repetition fallback for an SBFD-aware UE). For example, the device 1305 or a component of the device 1305 may include at least one processor 1335 and at least one memory 1325 coupled with one or more of the at least one processor 1335, the at least one processor 1335 and the at least one memory 1325 configured to perform various functions described herein. The at least one processor 1335 may be an example of a cloud-computing platform (e.g., one or more physical nodes and supporting software such as operating systems, virtual machines, or container instances) that may host the functions (e.g., by executing code 1330) to perform the functions of the device 1305. The at least one processor 1335 may be any one or more suitable processors capable of executing scripts or instructions of one or more software programs stored in the device 1305 (such as within one or more of the at least one memory 1325).

In some examples, the at least one processor 1335 may include multiple processors and the at least one memory 1325 may include multiple memories. One or more of the multiple processors may be coupled with one or more of the multiple memories, which may, individually or collectively, be configured to perform various functions herein. In some examples, the at least one processor 1335 may be a component of a processing system, which may refer to a system (such as a series) of machines, circuitry (including, for example, one or both of processor circuitry (which may include the at least one processor 1335) and memory circuitry (which may include the at least one memory 1325)), or components, that receives or obtains inputs and processes the inputs to produce, generate, or obtain a set of outputs. The processing system may be configured to perform one or more of the functions described herein. For example, the at least one processor 1335 or a processing system including the at least one processor 1335 may be configured to, configurable to, or operable to cause the device 1305 to perform one or more of the functions described herein. Further, as described herein, being “configured to,” being “configurable to,” and being “operable to” may be used interchangeably and may be associated with a capability, when executing code stored in the at least one memory 1325 or otherwise, to perform one or more of the functions described herein.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the at least one memory 1325, the code 1330, and the at least one processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with one or more other network entities 105, and may include a controller or scheduler for controlling communications with UEs 115 (e.g., in cooperation with the one or more other network devices). In some examples, the communications manager 1320 may support an X2 interface within an LTE/LTE-A wireless communications network technology to provide communication between network entities 105.

The communications manager 1320 may support wireless communications in accordance with examples as disclosed herein. For example, the communications manager 1320 is capable of, configured to, or operable to support a means for outputting configuration information indicating a first quantity of HD ROs and a first quantity of SBFD ROs for a RACH procedure. The communications manager 1320 is capable of, configured to, or operable to support a means for monitoring for, via the first quantity of HD ROs and the first quantity of SBFD ROs, a first set of repetitions of a PRACH message of the RACH procedure in accordance with the configuration information. The communications manager 1320 is capable of, configured to, or operable to support a means for obtaining a second set of repetitions of the PRACH message via a second quantity of HD ROs, a second quantity of SBFD ROs, or both, based on a failure of the RACH procedure associated with the first set of repetitions of the PRACH message, where the second quantity of HD ROs is different from the first quantity of HD ROs, the second quantity of SBFD-duplex ROs is different from the first quantity of SBFD ROs, or both.

By including or configuring the communications manager 1320 in accordance with examples as described herein, the device 1305 may support techniques for improved communication reliability, reduced latency and improved user experience related to more efficient utilization of communication resources and improved coordination between devices.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the transceiver 1310, one or more of the at least one processor 1335, one or more of the at least one memory 1325, the code 1330, or any combination thereof (for example, by a processing system including at least a portion of the at least one processor 1335, the at least one memory 1325, the code 1330, or any combination thereof). For example, the code 1330 may include instructions executable by one or more of the at least one processor 1335 to cause the device 1305 to perform various aspects of PRACH repetition fallback for an SBFD-aware UE as described herein, or the at least one processor 1335 and the at least one memory 1325 may be otherwise configured to, individually or collectively, perform or support such operations.

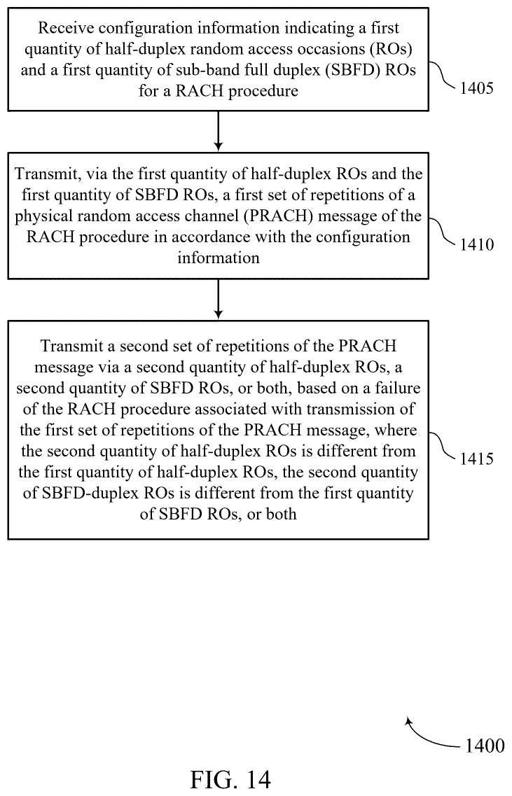

FIG. 14 shows a flowchart illustrating a method 1400 that supports PRACH repetition fallback for an SBFD-aware UE in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include receiving configuration information indicating a first quantity of HD ROs and a first quantity of SBFD ROs for a RACH procedure. The operations of 1405 may be performed in accordance with examples as disclosed herein. In some examples, aspects of the operations of 1405 may be performed by a configuration information component 825 as described with reference to FIG. 8.

At 1410, the method may include transmitting, via the first quantity of HD ROs and the first quantity of SBFD ROs, a first set of repetitions of a PRACH message of the RACH procedure in accordance with the configuration information. The operations of 1410 may be performed in accordance with examples as disclosed herein. In some examples, aspects of the operations of 1410 may be performed by a PRACH repetition component 830 as described with reference to FIG. 8.

At 1415, the method may include transmitting a second set of repetitions of the PRACH message via a second quantity of HD ROs, a second quantity of SBFD ROs, or both, based on a failure of the RACH procedure associated with transmission of the first set of repetitions of the PRACH message, where the second quantity of HD ROs is different from the first quantity of HD ROs, the second quantity of SBFD-duplex ROs is different from the first quantity of SBFD ROs, or both. The operations of 1415 may be performed in accordance with examples as disclosed herein. In some examples, aspects of the operations of 1415 may be performed by a PRACH repetition component 830 as described with reference to FIG. 8.

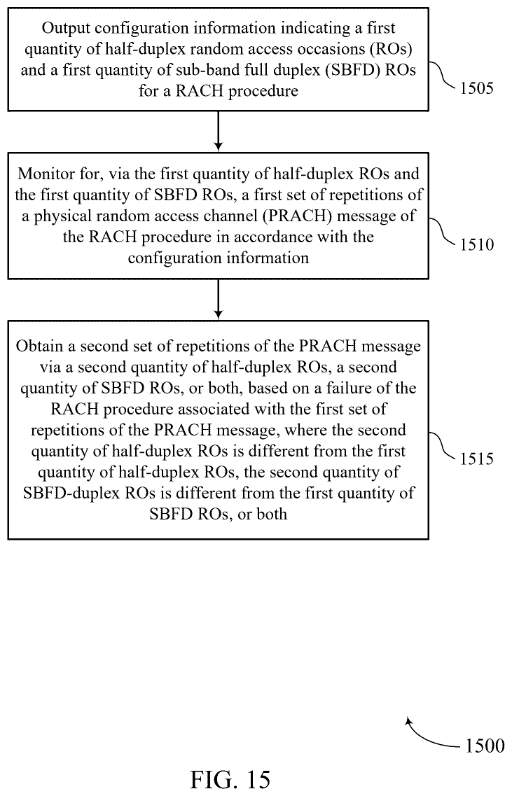

FIG. 15 shows a flowchart illustrating a method 1500 that supports PRACH repetition fallback for an SBFD-aware UE in accordance with one or more aspects of the present disclosure. The operations of the method 1500 may be implemented by a network entity or its components as described herein. For example, the operations of the method 1500 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1505, the method may include outputting configuration information indicating a first quantity of HD ROs and a first quantity of SBFD ROs for a RACH procedure. The operations of 1505 may be performed in accordance with examples as disclosed herein. In some examples, aspects of the operations of 1505 may be performed by a configuration information manager 1225 as described with reference to FIG. 12.

At 1510, the method may include monitoring for, via the first quantity of HD ROs and the first quantity of SBFD ROs, a first set of repetitions of a PRACH message of the RACH procedure in accordance with the configuration information. The operations of 1510 may be performed in accordance with examples as disclosed herein. In some examples, aspects of the operations of 1510 may be performed by a monitoring manager 1230 as described with reference to FIG. 12.

At 1515, the method may include obtaining a second set of repetitions of the PRACH message via a second quantity of HD ROs, a second quantity of SBFD ROs, or both, based on a failure of the RACH procedure associated with the first set of repetitions of the PRACH message, where the second quantity of HD ROs is different from the first quantity of HD ROs, the second quantity of SBFD-duplex ROs is different from the first quantity of SBFD ROs, or both. The operations of 1515 may be performed in accordance with examples as disclosed herein. In some examples, aspects of the operations of 1515 may be performed by a PRACH repetition manager 1235 as described with reference to FIG. 12.

The following provides an overview of aspects of the present disclosure:
Aspect 1: A method for wireless communications at a UE, comprising: receiving configuration information indicating a first quantity of HD ROs and a first quantity of SBFD ROs for a RACH procedure; transmitting, via the first quantity of HD ROs and the first quantity of SBFD ROs, a first set of repetitions of a PRACH message of the RACH procedure in accordance with the configuration information; transmitting a second set of repetitions of the PRACH message via a second quantity of HD ROs, a second quantity of SBFD ROs, or both, based at least in part on a failure of the RACH procedure associated with transmission of the first set of repetitions of the PRACH message, wherein the second quantity of HD ROs is different from the first quantity of HD ROs, the second quantity of SBFD-duplex ROs is different from the first quantity of SBFD ROs, or both.
Aspect 2: The method of aspect 1, wherein a quantity of repetitions of the second set of repetitions is greater than a quantity of repetitions of the first set of repetitions.
Aspect 3: The method of any of aspects 1 through 2, wherein the second quantity of HD ROs is greater than the first quantity of HD ROs.
Aspect 4: The method of any of aspects 1 through 3, wherein the second quantity of SBFD ROs is zero and the second quantity of HD ROs is equal to a sum of the first quantity of HD ROs and the first quantity of SBFD ROs.
Aspect 5: The method of any of aspects 1 through 4, wherein the first quantity of SBFD ROs is zero, the second quantity of HD ROs is greater than the first quantity of HD ROs, and the second quantity of SBFD ROs are determined opportunistically.
Aspect 6: The method of any of aspects 1 through 5, wherein the first quantity of SBFD ROs are determined opportunistically and the second quantity of HD ROs is greater than the first quantity of HD ROs.
Aspect 7: The method of any of aspects 1 through 6, wherein the first quantity of SBFD ROs is zero and the second quantity of HD ROs is greater than the first quantity HD ROs, or the first quantity of HD ROs is zero and the second quantity of SBFD ROs is greater than the first quantity SBFD ROs.
Aspect 8: The method of any of aspects 1 through 7, wherein upon the first quantity of HD ROs being zero, the second quantity of HD ROs is equal to the first quantity of SBFD ROs.
Aspect 9: The method of any of aspects 1 through 8, wherein upon the first quantity of HD ROs being zero, the second quantity of HD ROs is greater than the first quantity of SBFD ROs.
Aspect 10: The method of any of aspects 1 through 9, wherein the configuration information comprises an indication of a quantity of repetitions that the UE is to transmit.
Aspect 11: A method for wireless communications at a network entity, comprising: outputting configuration information indicating a first quantity of HD ROs and a first quantity of SBFD ROs for a RACH procedure; monitoring for, via the first quantity of HD ROs and the first quantity of SBFD ROs, a first set of repetitions of a PRACH message of the RACH procedure in accordance with the configuration information; obtaining a second set of repetitions of the PRACH message via a second quantity of HD ROs, a second quantity of SBFD ROs, or both, based at least in part on a failure of the RACH procedure associated with the first set of repetitions of the PRACH message, wherein the second quantity of HD ROs is different from the first quantity of HD ROs, the second quantity of SBFD-duplex ROs is different from the first quantity of SBFD ROs, or both.
Aspect 12: The method of aspect 11, wherein a quantity of repetitions of the second set of repetitions is greater than a quantity of repetitions of the first set of repetitions.
Aspect 13: The method of any of aspects 11 through 12, wherein the second quantity of HD ROs is greater than the first quantity of HD ROs.
Aspect 14: The method of any of aspects 11 through 13, wherein the second quantity of SBFD ROs is zero and the second quantity of HD ROs is equal to a sum of the first quantity of HD ROs and the first quantity of SBFD ROs.
Aspect 15: The method of any of aspects 11 through 14, wherein the first quantity of SBFD ROs is zero, the second quantity of HD ROs is greater than the first quantity of HD ROs, and the second quantity of SBFD ROs are determined opportunistically.
Aspect 16: The method of any of aspects 11 through 15, wherein the first quantity of SBFD ROs are determined opportunistically and the second quantity of HD ROs is greater than the first quantity of HD ROs.
Aspect 17: The method of any of aspects 11 through 16, wherein the first quantity of SBFD ROs is zero and the second quantity of HD ROs is greater than the first quantity HD ROs, or the first quantity of HD ROs is zero and the second quantity of SBFD ROs is greater than the first quantity SBFD ROs.
Aspect 18: The method of any of aspects 11 through 17, wherein upon the first quantity of HD ROs being zero, the second quantity of HD ROs is equal to the first quantity of SBFD ROs.
Aspect 19: The method of any of aspects 11 through 18, wherein upon the first quantity of HD ROs being zero, the second quantity of HD ROs is greater than the first quantity of SBFD ROs.
Aspect 20: The method of any of aspects 11 through 19, wherein the configuration information comprises an indication of a quantity of repetitions that a UE is to transmit.
Aspect 21: A UE for wireless communications, comprising one or more memories storing processor-executable code, and one or more processors coupled with the one or more memories and individually or collectively operable to execute the code to cause the UE to perform a method of any of aspects 1 through 10.
Aspect 22: A UE for wireless communications, comprising at least one means for performing a method of any of aspects 1 through 10.
Aspect 23: A non-transitory computer-readable medium storing code for wireless communications, the code comprising instructions executable by one or more processors to perform a method of any of aspects 1 through 10.
Aspect 24: A network entity for wireless communications, comprising one or more memories storing processor-executable code, and one or more processors coupled with the one or more memories and individually or collectively operable to execute the code to cause the network entity to perform a method of any of aspects 11 through 20.
Aspect 25: A network entity for wireless communications, comprising at least one means for performing a method of any of aspects 11 through 20.
Aspect 26: A non-transitory computer-readable medium storing code for wireless communications, the code comprising instructions executable by one or more processors to perform a method of any of aspects 11 through 20.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive configuration information indicating a first quantity of half-duplex random access occasions (ROs) and a first quantity of sub-band full duplex (SBFD) ROs for a random access channel (RACH) procedure;
transmit, via the first quantity of half-duplex ROs and the first quantity of SBFD ROs, a first set of repetitions of a physical random access channel (PRACH) message of the RACH procedure in accordance with the configuration information; and
transmit a second set of repetitions of the PRACH message via a second quantity of half-duplex ROs, a second quantity of SBFD ROs, or both, based at least in part on a failure of the RACH procedure associated with transmission of the first set of repetitions of the PRACH message,
wherein the second quantity of half-duplex ROs is different from the first quantity of half-duplex ROs, the second quantity of SBFD-duplex ROs is different from the first quantity of SBFD ROs, or both.

2. The UE of claim 1, wherein a quantity of repetitions of the second set of repetitions is greater than a quantity of repetitions of the first set of repetitions.

3. The UE of claim 1, wherein the second quantity of half-duplex ROs is greater than the first quantity of half-duplex ROs.

4. The UE of claim 1, wherein the second quantity of SBFD ROs is zero and the second quantity of half-duplex ROs is equal to a sum of the first quantity of half-duplex ROs and the first quantity of SBFD ROs.

5. The UE of claim 1, wherein the first quantity of SBFD ROs is zero, the second quantity of half-duplex ROs is greater than the first quantity of half-duplex ROs, and the second quantity of SBFD ROs are determined opportunistically.

6. The UE of claim 1, wherein the first quantity of SBFD ROs are determined opportunistically and the second quantity of half-duplex ROs is greater than the first quantity of half-duplex ROs.

7. The UE of claim 1, wherein:
the first quantity of SBFD ROs is zero and the second quantity of half-duplex ROs is greater than the first quantity of half-duplex ROs, or
the first quantity of half-duplex ROs is zero and the second quantity of SBFD ROs is greater than the first quantity of SBFD ROs.

8. The UE of claim 1, wherein upon the first quantity of half-duplex ROs being zero, the second quantity of half-duplex ROs is equal to the first quantity of SBFD ROs.

9. The UE of claim 1, wherein upon the first quantity of half-duplex ROs being zero, the second quantity of half-duplex ROs is greater than the first quantity of SBFD ROs.

10. The UE of claim 1, wherein the configuration information comprises an indication of a quantity of repetitions that the UE is to transmit.

11. A network entity, comprising:
one or more memories storing processor-executable code; and
one or more processors coupled with the one or more memories and individually or collectively operable to execute the code to cause the network entity to:
output configuration information indicating a first quantity of half-duplex random access occasions (ROs) and a first quantity of sub-band full duplex (SBFD) ROs for a random access channel (RACH) procedure;
monitor for, via the first quantity of half-duplex ROs and the first quantity of SBFD ROs, a first set of repetitions of a physical random access channel (PRACH) message of the RACH procedure in accordance with the configuration information; and
obtain a second set of repetitions of the PRACH message via a second quantity of half-duplex ROs, a second quantity of SBFD ROs, or both, based at least in part on a failure of the RACH procedure associated with the first set of repetitions of the PRACH message,
wherein the second quantity of half-duplex ROs is different from the first quantity of half-duplex ROs, the second quantity of SBFD-duplex ROs is different from the first quantity of SBFD ROs, or both.

12. The network entity of claim 11, wherein a quantity of repetitions of the second set of repetitions is greater than a quantity of repetitions of the first set of repetitions.

13. The network entity of claim 11, wherein the second quantity of half-duplex ROs is greater than the first quantity of half-duplex ROs.

14. The network entity of claim 11, wherein the second quantity of SBFD ROs is zero and the second quantity of half-duplex ROs is equal to a sum of the first quantity of half-duplex ROs and the first quantity of SBFD ROs.

15. The network entity of claim 11, wherein the first quantity of SBFD ROs is zero, the second quantity of half-duplex ROs is greater than the first quantity of half-duplex ROs, and the second quantity of SBFD ROs are determined opportunistically.

16. The network entity of claim 11, wherein the first quantity of SBFD ROs are determined opportunistically and the second quantity of half-duplex ROs is greater than the first quantity of half-duplex ROs.

17. The network entity of claim 11, wherein:
the first quantity of SBFD ROs is zero and the second quantity of half-duplex ROs is greater than the first quantity of half-duplex ROs, or
the first quantity of half-duplex ROs is zero and the second quantity of SBFD ROs is greater than the first quantity of SBFD ROs.

18. The network entity of claim 11, wherein upon the first quantity of half-duplex ROs being zero, the second quantity of half-duplex ROs is equal to the first quantity of SBFD ROs.

19. The network entity of claim 11, wherein upon the first quantity of half-duplex ROs being zero, the second quantity of half-duplex ROs is greater than the first quantity of SBFD ROs.

20. The network entity of claim 11, wherein the configuration information comprises an indication of a quantity of repetitions that a user equipment is to transmit.

21. A method for wireless communications at a user equipment (UE), comprising:
receiving configuration information indicating a first quantity of half-duplex random access occasions (ROs) and a first quantity of sub-band full duplex (SBFD) ROs for a random access channel (RACH) procedure;
transmitting, via the first quantity of half-duplex ROs and the first quantity of SBFD ROs, a first set of repetitions of a physical random access channel (PRACH) message of the RACH procedure in accordance with the configuration information; and
transmitting a second set of repetitions of the PRACH message via a second quantity of half-duplex ROs, a second quantity of SBFD ROs, or both, based at least in part on a failure of the RACH procedure associated with transmission of the first set of repetitions of the PRACH message,
wherein the second quantity of half-duplex ROs is different from the first quantity of half-duplex ROs, the second quantity of SBFD-duplex ROs is different from the first quantity of SBFD ROs, or both.

22. The method of claim 21, wherein a quantity of repetitions of the second set of repetitions is greater than a quantity of repetitions of the first set of repetitions.

23. The method of claim 21, wherein the second quantity of half-duplex ROs is greater than the first quantity of half-duplex ROs.

24. The method of claim 21, wherein the second quantity of SBFD ROs is zero and the second quantity of half-duplex ROs is equal to a sum of the first quantity of half-duplex ROs and the first quantity of SBFD ROs.

25. The method of claim 21, wherein the first quantity of SBFD ROs is zero, the second quantity of half-duplex ROs is greater than the first quantity of half-duplex ROs, and the second quantity of SBFD ROs are determined opportunistically.

26. The method of claim 21, wherein the first quantity of SBFD ROs are determined opportunistically and the second quantity of half-duplex ROs is greater than the first quantity of half-duplex ROs.

27. A method for wireless communications at a network entity, comprising:
outputting configuration information indicating a first quantity of half-duplex random access occasions (ROs) and a first quantity of sub-band full duplex (SBFD) ROs for a random access channel (RACH) procedure;
monitoring for, via the first quantity of half-duplex ROs and the first quantity of SBFD ROs, a first set of repetitions of a physical random access channel (PRACH) message of the RACH procedure in accordance with the configuration information; and
obtaining a second set of repetitions of the PRACH message via a second quantity of half-duplex ROs, a second quantity of SBFD ROs, or both, based at least in part on a failure of the RACH procedure associated with the first set of repetitions of the PRACH message,
wherein the second quantity of half-duplex ROs is different from the first quantity of half-duplex ROs, the second quantity of SBFD-duplex ROs is different from the first quantity of SBFD ROs, or both.

28. The method of claim 27, wherein:
the first quantity of SBFD ROs is zero and the second quantity of half-duplex ROs is greater than the first quantity of half-duplex ROs, or
the first quantity of half-duplex ROs is zero and the second quantity of SBFD ROs is greater than the first quantity of SBFD ROs.

29. The method of claim 27, wherein upon the first quantity of half-duplex ROs being zero, the second quantity of half-duplex ROs is equal to the first quantity of SBFD ROs.

30. The method of claim 27, wherein upon the first quantity of half-duplex ROs being zero, the second quantity of half-duplex ROs is greater than the first quantity of SBFD ROs.
